(19) United States
(12) Patent Application Publication
(10) Pub. No.: US 2025/0330094 A1
(43) Pub. Date: Oct. 23, 2025

(54) MULTI-PHASE POWER SUPPLY SYSTEM WITH SELF CURRENT BALANCE CAPABILITY

(71) Applicant: Infineon Technologies Austria AG, Villach (AT)

(72) Inventors: Sutej R. CHALLA, Action, MA (US); Darryl TSCHIRHART, Newmarket (CA); Danny R. Clavette, Greene, RI (US)

(21) Appl. No.: 18/638,150

(22) Filed: Apr. 17, 2024

(51) Int. Cl. H02M 3/158; H02M 1/00; H02M 1/088

(52) U.S. Cl. CPC H02M 3/1586; H02M 1/0025; H02M 1/088

(57) ABSTRACT

An apparatus includes a power converter controller. The power converter controller receives first input. A magnitude of the first input is derived from combined output current supplied from multiple power converters to a load. The power converter controller also receives second input indicating a magnitude of first output current supplied from a first power converter of the multiple power converters to the load. The combined output current includes the first output current supplied from the first power converter to the load. Based on a comparison of the second input to the first input, the power converter controller adjusts a leading edge and/or a trailing edge of a first pulse width modulation control signal. Additional examples of supporting signal edge control are discussed herein.

### BACKGROUND

One type of conventional power converter is a buck converter. In general, to maintain an output voltage within a desired range, a controller associated with the buck converter compares the magnitude of a generated output voltage to a setpoint reference voltage. Based on a respective error voltage, the controller modifies a respective switching frequency and/or pulse width modulation associated with activating high side switch circuitry and low side switch circuitry in the buck converter to maintain a magnitude of the output voltage.

In certain instances, the controller controls operation of the buck converter and generation of the output voltage based on an amount of output current supplied by a generated output voltage to a load. For example, conventional techniques include receiving a so-called VID (Voltage Identification) from a load such as a processor being powered by the output voltage. The VID indicates a setpoint voltage in which to produce the output voltage to power the load. The magnitude of the VID setting (such as setpoint reference voltage) may vary depending on a magnitude of the output current. In a manner as previously discussed, the controller of the power supply can be configured to regulate a magnitude of the output voltage supplied to the load based on a target setpoint voltage derived from the received VID value.

Conventional power supply systems may include implementation of multiple buck converters in parallel to produce a respective output voltage that powers a load. Typically the power supply system includes a single controller operative to generate control signals for each of the multiple power converter phases. If there are many phases controlled by the single controller, many circuit paths are needed to support conveyance of control signals to each of the multiple power converter phases. Additionally, each of the power converter phases provides individual feedback to the single controller. Thus, additional circuit paths are needed to convey the feedback from the multiple power converter phases to the single controller.

### BRIEF DESCRIPTION

Implementation of clean energy (or green technology) is very important to reduce our impact as humans on the environment. In general, clean energy includes any evolving methods and materials to reduce an overall toxicity to the environment as caused by energy consumption.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, etc. Regardless of whether energy is received from green energy sources or non-green energy sources, it is desirable to make most efficient use of raw energy provided by such systems to reduce our impact on the environment. This disclosure contributes to reducing our carbon footprint (and green energy) via more efficient energy conversion.

Additionally, this disclosure includes the observation that it is desirable to reduce the number of circuit paths needed to support conveyance signals between a controller and multiple power converter phases controlled by the controller. Reducing a number of circuit paths beneficially reduces the complexly of implementing a respective power supply including corresponding multiple power converter phases.

More specifically, a controller as discussed herein is operative to: receive first input, a magnitude of the first input derived from combined output current supplied from multiple power converters to a load; receive second input indicating a magnitude of first output current supplied from a first power converter of the multiple power converters to the load, the combined output current including the first output current; and based on a comparison of the second input to the first input, adjust an one or more edge such as a leading edge and/or a trailing edge of a first pulse width modulation control signal.

In accordance with further examples as discussed herein, the first pulse width modulation control signal is operative to control a magnitude of the first output current supplied from the first power converter.

In one example, the adjusted leading edge and/or the trailing edge of the first pulse width modulation control signal sets (controls) the magnitude of the first output current supplied from the first power converter to be substantially equal to the magnitude of the first input. A magnitude of the first input can be configured to indicate an average magnitude of current supplied from the multiple power converters to the load.

In accordance with another example, the first pulse width modulation control signal and the second pulse width modulation control signal are generated at a same frequency. Alternatively, the first pulse width modulation control signal and the second pulse width modulation control signal are generated at different frequencies.

Another example as discussed herein includes a first power converter controller operative to: receive a first control signal from a current controller, the first control signal generated by the current controller to control delivery of output currents from multiple power converters to a load; derive a second control signal from the received first control signal, the second control signal operative to control a first power converter; and wherein the second control signal includes a leading edge followed by a trailing edge, the leading edge of the second control signal adjusted over time by the first power converter controller to balance magnitudes of the output currents from the multiple converters. In one example, the leading edge of the second control signal is adjusted based on a difference between an average magnitude of the output currents and a determined magnitude of the first output current outputted from the first power converter to the load.

Still further examples as discussed herein include an apparatus comprising a first power converter controller. The first power converter controller can be configured to: output a first output signal from the first power converter controller over a shared signal path to a current controller, the first output signal indicating a magnitude of first output current supplied by a first power converter phase to a load, the shared signal path operative to receive a second output signal from a second power converter controller, the second output signal indicating a magnitude of second output current supplied by the second power converter to the load; receive a first control signal from the current controller, the first control signal generated by the current controller based on the first output signal and the second output signal; and derive a second control signal from the received first control signal, a pulse width of the second control signal being adjusted with respect to a pulse width of the first control signal.

In accordance with further examples as discussed herein, the first power converter controller is further operative to derive the second control signal based on a first delay value and a second delay value. A leading edge of the first control signal is delayed by the first delay value to produce a leading edge of the second control signal; a trailing edge of the first control signal is delayed by the second delay value to produce a trailing edge of the second control signal.

In yet further examples, the first power converter controller is further operative to: receive an input signal from the shared signal path, the received input signal indicating an average magnitude value based on the first output current supplied by the first power converter phase to the load and the second output current supplied by the second power converter phase to the load; receive a first current monitor signal indicating the magnitude of the first output current; and produce the first delay value and the second delay value based on a comparison of: i) the received input signal indicating the average magnitude value, and ii) the first current monitor signal indicating the magnitude of the first output current.

Still further, the first power converter controller can be configured to: adjust a magnitude of the first delay value and a magnitude of the second delay value such that the magnitude of the second pulse width is greater than the magnitude of the first pulse width in response to detecting a condition in which the magnitude of the first output current is less than the average magnitude value.

In accordance with another example, the first power converter controller can be configured to: adjust a magnitude of the first delay value and a magnitude of the second delay value such that the magnitude of the second pulse width is less than the magnitude of the first pulse width in response to detecting a condition in which the magnitude of the first output current is less than the average magnitude value.

In further examples, the first control signal is a first pulse width modulation control signal. The first power converter controller is operative to control the magnitude of the first output current based on the first pulse width modulation control signal received from the current controller. The second power converter controller is operative to control the magnitude of the second output current based on the first pulse width modulation control signal received from the current controller. The first control signal is a first pulse width modulation control signal. The first power converter controller is operative to control the magnitude of the first output current based on the first pulse width modulation control signal received from the current controller. The second power converter controller is operative to control the magnitude of the second output current based on a second pulse width modulation control signal received from the current controller.

In another example, the first power converter controller as discussed herein may be further operative to: generate a first error signal based on a difference between a target value associated with producing the magnitude of the first output current and a measured magnitude of the first output current supplied to the load; and generate a second error signal based on a difference between the target value associated with producing the magnitude of the first output current and the measured magnitude of the first output current supplied to the load. Depending on a magnitude and polarity of the first error signal, the first power converter controller adjusts timing of a leading edge of the second control signal; depending on a magnitude and polarity of the second error signal, the first power converter controller adjusts timing of a trailing edge of the second control signal. These operations can be performed in the same or different control cycles.

Still further, the first power converter controller can be configured to: control activation of high side switch circuitry in the first power converter via the second control signal, the controlled activation of the high side switch circuitry using the second control signal operative to substantially equalize the magnitude of the first output current and the second output current over time.

In yet further examples, derivation of the control signal from the received first control signal includes: selection of a first delay signal from a first tapped delay line to control a respective timing of a leading edge of the second control signal; and selection of a second delay signal from a second tapped delay line to control a respective timing of a trailing edge of the second control signal. As previously discussed, the delay signals can be selected in different control cycles.

Still further, the first power converter controller can be configured to: implement a first current starved inverter circuit to convert the first control signal into the second control signal, the first current starved inverter circuit operative to control timing of a leading edge of the second control signal; and implement a second current starved inverter circuit to convert the first control signal into the second control signal, the second current starved inverter circuit operative to control timing of a trailing edge of the second control signal. A magnitude of a first delay amount may be provided by the first current starved inverter circuit to control the timing of the leading edge of the second control signal, which may be based on a first error signal representing a difference between a target value of controlling the magnitude of the first output current with respect to a measured magnitude of the first output current; and a magnitude of a second delay provided by the second current starved inverter circuit to control the timing of the trailing edge of the second control signal may be based on a second error signal representing a difference between the measured magnitude of the first output current with respect to the target value of controlling the magnitude of the first output current.

In another example, the first power converter controller can be configured to: implement a first continuous delay element circuit to convert the first control signal into the second control signal, the first continuous delay element circuit may be operative to control timing of a leading edge of the second control signal; and implement a second continuous delay element circuit to convert the first control signal into the second control signal, the second continuous delay element circuit operative to control timing of a trailing edge of the second control signal. As previously discussed, the adjustment to the leading edge and the trailing edge may occur in the same or different control cycles

Techniques as discussed herein are useful over conventional techniques. For example, the adjustments to a common pulse width modulation control signal by multiple power converter controllers to control their respective power converter provides a novel distributed control function supporting signal path reduction. This, in turn, supports efficient power conversion via less complex power converter circuitry.

These and other more specific examples are disclosed in more detail below.

Note that although examples as discussed herein are applicable to power converters, the concepts disclosed herein may be advantageously applied to any other suitable topologies as well as general power supply control applications.

Note that any of the resources as discussed herein can include one or more computerized devices, controller, mobile communication devices, servers, base stations, wireless communication equipment, communication management systems, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to methods, systems, computer program products, etc., that support operations as discussed herein.

One example herein includes a computer readable storage medium and/or system having instructions stored thereon. The instructions, when executed by computer processor hardware, cause the computer processor hardware (such as one or more co-located or disparately located processor devices) to: receive a first control signal from a current controller, the first control signal generated by the current controller to control delivery of output currents from multiple power converters to a load; derive a second control signal from the received first control signal, the second control signal operative to control first output current from a first power converter controlled by the first power converter controller; and wherein the second control signal includes a leading edge followed by a trailing edge, the leading edge of the second control signal adjusted over time by the first power converter controller to balance magnitudes of the output currents from the multiple converters.

Another example herein includes a computer readable storage medium and/or system having instructions stored thereon. The instructions, when executed by computer processor hardware, cause the computer processor hardware (such as one or more co-located or disparately located processor devices) to: receive first input, a magnitude of the first input derived from combined output current supplied from multiple power converters to a load; receive second input indicating a magnitude of first output current supplied from a first power converter of the multiple power converters to the load, the combined output current including the first output current; and based on a comparison of the second input to the first input, adjust a leading edge and a trailing edge of a first pulse width modulation control signal.

The ordering of the steps above has been added for clarity sake. Note that any of the processing operations as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be implemented strictly as a software program, firmware, as a hybrid of software, hardware and/or firmware, or as hardware alone such as within a processor (hardware or software), or within an operating system or a within a software application.

As discussed herein, techniques herein are well suited for use in the field of implementing one or more power converters to deliver current to a load. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1A is an example diagram illustrating implementation of a power converter including multiple power converter phases controlled by a multiphase controller as discussed herein.

FIG. 1B is an example diagram illustrating a power converter and corresponding circuitry as discussed herein.

FIG. 2A is an example diagram illustrating implementation of the power converter including multiple power converter phases controlled by a multiphase controller as discussed herein.

FIG. 2B is an example diagram illustrating a power converter and corresponding circuitry as discussed herein.

FIG. 3 is an example timing diagram illustrating adjustment of a trailing edge of a pulse width modulation control signal to produce an outputted control signal as discussed herein.

FIG. 4 is an example timing diagram illustrating adjustment of a leading edge of a pulse width modulation control signal to produce an output control signal as discussed herein.

FIG. 5 is an example diagram illustrating a pulse width modulation signal generator operable to adjust leading and/or trailing edges of a respective received control signal as discussed herein.

FIG. 6 is an example diagram illustrating a pulse width modulation signal generator operable to adjust leading and/or trailing edges of a respective received control signal as discussed herein.

FIG. 7 is an example diagram illustrating a variable delay circuit operative to delay a clock signal as discussed herein.

FIG. 8 is an example diagram illustrating delay versus input voltage associated with the variable delay circuit as discussed herein.

FIG. 9 is an example diagram illustrating a hybrid pulse width modulation signal generator providing edge delay as discussed herein.

FIG. 10 is an example diagram illustrating a hybrid pulse width modulation signal generator providing edge delay as discussed herein.

FIG. 11 is an example diagram illustrating computer processor hardware and related software instructions operative to execute methods as discussed herein.

FIG. 12 is an example diagram illustrating a method and corresponding functionality associated with a circuit as discussed herein.

FIG. 13 is an example diagram illustrating a method and corresponding functionality associated with a circuit as discussed herein.

FIG. 14 is an example diagram illustrating a method and corresponding functionality associated with a circuit as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

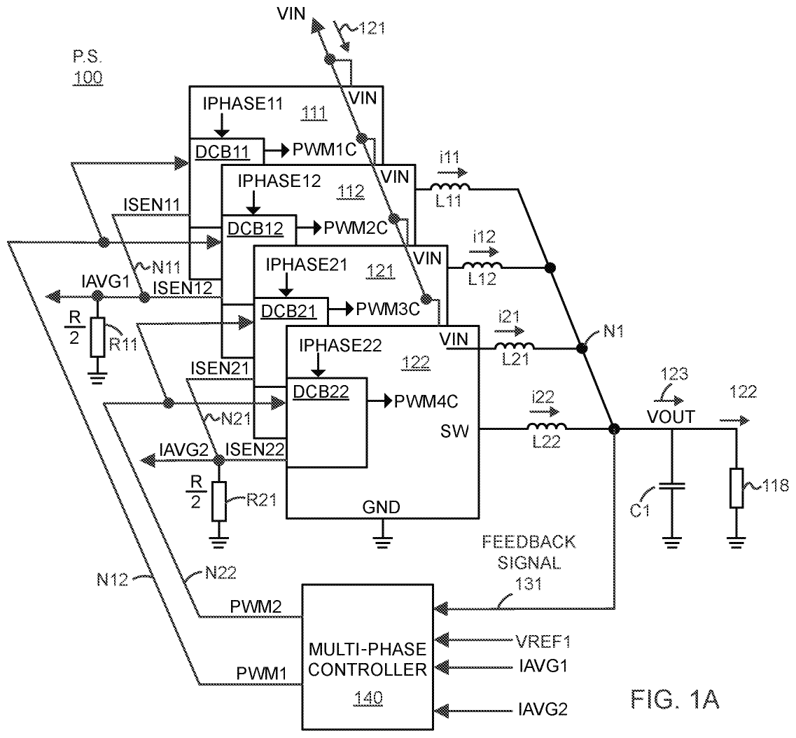

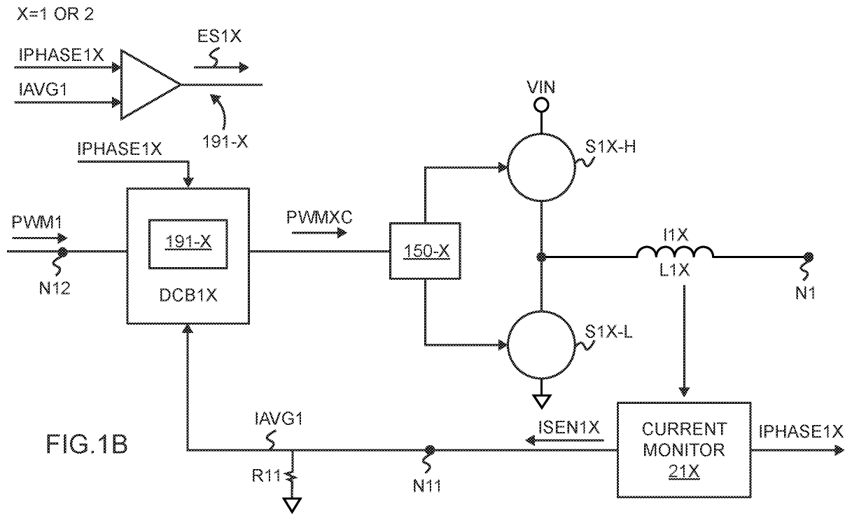

FIG. 1A is an example diagram illustrating implementation of a power converter including multiple power converter phases controlled by a multiphase controller as discussed herein.

As shown, power supply 100 in FIG. 1A includes controller 140 (such as a multiphase controller, current controller, controller hardware, etc.), resistor R11, resistor R21, power converter phase 111, power converter phase 112, power converter phase 121, power converter phase 122, output capacitor C1, and dynamic load 118.

Each of the power converters as discussed herein can be configured to include a respective current balancer function (a.k.a., current balancer, controller, hardware, circuitry, etc., such as being digital-circuit-based, analog-circuit-based, or a combination of analog-circuit-based and digital-circuit-based).

For example, the power converter phase 111 includes current balance function DCB11, the power converter phase 112 includes current balance function DCB12, the power converter phase 121 includes current balance function DCB21, the power converter phase 122 includes the current balance function DCB22.

Accordingly, each current balance function as discussed herein can be considered a controller, signal generator, etc.

Each of the power converter phases in the power supply 100 produces a respective feedback signal indicating a magnitude of corresponding current supplied by that power converter phase to the load 118.

For example, the power converter phase 111 includes a corresponding current monitor operative to measure a magnitude of the current i11 supplied by the power converter phase 111 through the inductor L11 to the corresponding load 118. The current i11 contributes to maintaining a magnitude of the output voltage 123 at a desired setpoint reference voltage VREF1. The current balance function DCB11 produces the respective output signal ISEN11 indicating a magnitude of the current i11. In one example, the signal ISEN11 is a current proportional to the magnitude of the current i11. The signal ISEN11 is outputted from the corresponding current balance function DCB11 to the node N11 (circuit path), where the corresponding current from the signal ISEN11 flows through the resistor R11 to the ground reference voltage.

The power converter phase 112 includes a corresponding current monitor operative to measure a magnitude of the current i12 supplied by the power converter phase 112 through the inductor L12 to the corresponding load 118. The current i12 contributes to maintaining a magnitude of the output voltage 123 at a desired setpoint reference voltage VREF1. The current balance function DCB12 produces the respective signal ISEN12 indicating a magnitude of the current i12. In one example, the signal ISEN12 is an outputted current proportional to the magnitude of the current i12. The signal ISEN12 is outputted from the corresponding current balance function DCB12 to the node N11, where the corresponding current from the signal ISEN12 flows through the resistor R11 to the ground reference voltage.

In such an instance, the voltage IAVG1 at node N11 indicates a magnitude of total current (such as magnitude of total current as being summation of current i11 and current i12) provided by the power converter phase 111 and power converter phase 112 to the load 118. Accordingly, communication of the signal IAVG1 to the controller 140 indicates a total current provided by a combination of the power converter phase 111 and the power converter phase 112 to the load 118.

The power converter phase 121 includes a corresponding current monitor operative to measure a magnitude of the current i21 supplied by the power converter phase 121 through the inductor L21 to the corresponding load 118. The current i21 contributes to maintaining a magnitude of the output voltage 123 at a desired setpoint reference voltage VREF1. The current balance function DCB21 produces the respective signal ISEN21 indicating a magnitude of the current i21. In one example, the signal ISEN21 is a current proportional to the magnitude of the current i21. The signal ISEN21 is outputted from the corresponding current balance function DCB21 to the node N21 (such as circuit path), where the corresponding current from the signal ISEN21 flows through the resistor R21 to the ground reference voltage.

The power converter phase 122 includes a corresponding current monitor operative to measure a magnitude of the current i22 supplied by the power converter phase 112 through the inductor L22 to the corresponding load 118. The current i22 contributes to maintaining a magnitude of the output voltage 123 at a desired setpoint reference voltage VREF1. The current balance function DCB22 produces the respective signal ISEN22 indicating a magnitude of the current i22. In one example, the signal ISEN22 is a current proportional to the magnitude of the current i22. The signal ISEN22 is outputted from the corresponding current balance function DCB22 to the node N21, where the corresponding current from the signal ISEN22 flows through the resistor R21 to the ground reference voltage.

In such an instance, the voltage IAVG2 at node N12 indicates a magnitude of total current (such as magnitude of total current is being summation of current i21 and current i22) provided by the power converter phase 121 and power converter phase 122 to the load 118. Accordingly, communication of the signal IAVG2 to the controller 140 indicates a total current provided by a combination of the power converter phase 121 and the power converter phase 122 to the load 118.

As further shown in FIG. 1, the controller 140 can be configured to receive feedback signal 131 indicating a magnitude of the output voltage 123. Note further that the controller 140 also receives the setpoint reference voltage VREF1, indicating a desired magnitude wish to control the magnitude of the output voltage 123.

The controller 140 generates the pulse width modulation control signal PWM1 to control a magnitude of respective output current supplied by each of the power converter phase 111 and power converter phase 112 to the load 118. The controller 140 generates the pulse width modulation control signal PWM2 to control a magnitude of the respective output current supplied by each of the power converter phase 121 and power converter phase 122 to the load 118.

In furtherance of controlling (regulating) the magnitude of the output voltage 123, the controller 140 produces the respective pulse width modulation control signals PWM1 and PWM2. Each of the respective groups of power converter phases receives a respective pulse width modulation control signal indicating the target magnitude of controlling a respective output current to the load. Rather than simply use the received pulse width modulation control signal received from the controller 140, each of the power converter phases implements a respective current balance function that supports equalizing the magnitude of the output currents by that group (such as a first group including the power converter phase 111, power converter phase 112, etc., or a second group including the power converter phase 121, power converter phase 122, etc.) to the load 118.

More specifically, the controller 140 produces the respective pulse width modulation control signal PWM1 and supplies it over node N12 (i.e., circuit path) to the power converter phase 111 and the power converter phase 112.

As discussed herein, the respective current balance function each of the power converters adjusts the received pulse width modulation control signal PWM1 to control its respective output current such that each of the power converter supplies an equal amount of current (for example, i11 equals i12) to the load 118. Thus, the function of providing current balance amongst the multiple power converter phases as discussed herein is distributed to the power converter phases themselves as opposed to the controller 140 having the burden of producing and transmitting individual control signals to each of the power converter phases.

As further shown, the controller 140 produces the respective pulse width modulation control signal PWM2 and supplies it over node N22 (i.e., circuit path) to the power converter phase 121 and the power converter phase 122. As discussed herein, the respective current balance function each of the power converters adjusts the received pulse width modulation control signal PWM2 such that each of the power converter supplies an equal amount of current (for example, i21 equals i22) to the load 118. Thus, the function of providing current balance amongst the multiple power converter phases is distributed to the power converter phases themselves as opposed to the controller 140 having the burden of producing and transmitting individual control signals to each of the power converter phases.

It is further noted that the controller 140 can be configured to control the groupings of power converter phases to provide different magnitudes of current to the respective load 118. For example, the controller 140 can be configured to generate the control signal PWM1 to supply a first magnitude of current (sum of current i11 and i12 such as 20 amps or other suitable amount) from a combination of the power converter phase 111 and the power converter phase 112 to the load. The controller 140 can be configured to generate the control signal PWM2 to supply a second magnitude of current (sum of current i21 and i22 such as 40 amps or other suitable amount) from a combination of the power converter phase 121 and the power converter phase 122 to the load 118.

FIG. 1B is an example diagram illustrating a power converter and corresponding circuitry as discussed herein.

This example illustrates the circuitry associated with each of the power converter phases as shown in FIG. 1A. As discussed below, the value of X may be 1 or 2. If desired, this can be extended to include any number of power converter phases in parallel.

For example, each of the respective power converter phases (power converter phase 111, 112, etc.) includes a current balance function DCB1X, driver circuitry 150-X, highside switch circuitry SIX-H, low side switch circuitry SIX-L, inductor LIX, and current monitor 21X.

As previously discussed, the current balance function DCB1X receives the pulse width modulation control signal PWM1 generated by the controller 140. The current balance function DCB1X also receives a signal IPHASE1X indicating a magnitude of respective output current i1X supplied by that power converter phase to the load 118.

Additionally, as previously discussed, the current balance function DCB1X receives the signal IAVG1. The current balance function DCB1X further includes a comparator function 191-X (such as an error signal generator). As its name suggests, the comparator function 191-X (difference function) is operative to compare the signal IAVG1 (setpoint value or target value) to the signal (IPHASE1X) and produces the respective error signal ESIX. The error signal ES1X indicates a respective difference between the actual output current iX1 supplied to the load 118 with respect to the desired setpoint output current value IAVG1. For example the error signal ES1X can be set to signal IAVG1 minus signal IPHASE1X.

If the magnitude of the error signal ES1X is equal to 0, then the pulse width modulation control signal PWMXc outputted from the current balance function DCB1X is basically identical in pulse width to the received pulse width modulation signal PWMX with a small delay on each respective leading edge and trailing edge of the control signal PWMXc.

If the magnitude of the error signal ES1X is a negative value (polarity is a first state) indicating that the magnitude of the output current iX1 as indicated by the signal IPHASE1 is greater than a magnitude of current as indicated by the signal IAVG1, then the current balance function DCB1X produces the respective pulse width modulation control signal PWMXC for a next control cycle with a shorter duty cycle (shorter pulse width) of activating respective highside switch circuitry SIX-H with respect to the original duty cycle as indicated by the pulse width modulation control signal PWMX.

If the magnitude of the error signal ES1X is a positive value (polarity is a second state) indicating that the magnitude of the output current iX1 as indicated by the signal IPHASE1 is less than a magnitude of current as indicated by the signal IAVG1, then the current balance function DCB1X produces the respective pulse width modulation control signal PWMXC for a next control cycle with a higher duty cycle (longer pulse width on time of highside switch circuitry) of activating respective highside switch circuitry SIX-H with respect to the original duty cycle as indicated by the pulse width modulation control signal PWMX.

Thus, controlled activation of high side switch circuitry SIX-H in the first power converter phase via the control signal PWM1Xc can be used to substantially equalize the magnitude of the first output current i11 and the second output current i12 (such that the magnitudes are within 2 percent or other suitable value of each other) over time.

As discussed herein, the duty cycle or pulse width ON-time associated with the adjusted pulse width modulation control signal PWMXC can be increased or decreased by adjusting one or more of a leading edge or trailing edge of the corresponding control signal PWMXC. Thus, the leading edge or trailing edge of the control signal PWMXC can be adjusted based at least in part on a difference between an average magnitude of the output currents (IAVG1) and a determined magnitude of the first output current (IPHASE1X) outputted from the respective power converter (111 or 112 depending on the case) to the load 118.

Accordingly, examples herein include the current balance function DCB1X (i.e., a first power converter controller) operative to: receive an input signal (IAVG1) from the shared signal path (N11), the received input signal indicating an average magnitude value based on the first output current i11 supplied by the first power converter phase 111 to the load and the second output current i12 supplied by the second power converter phase 112 to the load; receive a first current monitor signal (IPHASE1X) indicating the magnitude of the first output current i11; and produce a first delay value and/or a second delay value based on a comparison of: i) the received input signal indicating the average magnitude value, and ii) the first current monitor signal indicating the magnitude of the first output current. The first power converter controller is further operative to derive the second control signal PWMXC based on a first delay value and a second delay value such as in the same or different control cycles; wherein a leading edge of the first control signal PWMX is delayed by the first delay value to produce a leading edge of the second control signal PWMXC; and wherein a trailing edge of the first control signal is delayed by the second delay value to produce a trailing edge of the second control signal.

As further discussed herein, current balance function DCB1X is further operative to: adjust a magnitude of the first delay value and a magnitude of the second delay value such that the magnitude of the second pulse width associated with the control signal PWMXc is greater than the magnitude of the first pulse width (associated with high side switch circuitry ON-time as indicated by PWM1) in response to detecting a condition in which the magnitude of the first output current is less than the average magnitude value.

As further discussed herein, the current balance function DCB1X is further operative to: adjust a magnitude of the first delay value and a magnitude of the second delay value such that the magnitude of the second pulse width associated with the control signal PWMXc is less than the magnitude of the first pulse width (associated with high side switch circuitry on time as indicated by PWM1) in response to detecting a condition in which the magnitude of the first output current is greater than the average magnitude value.

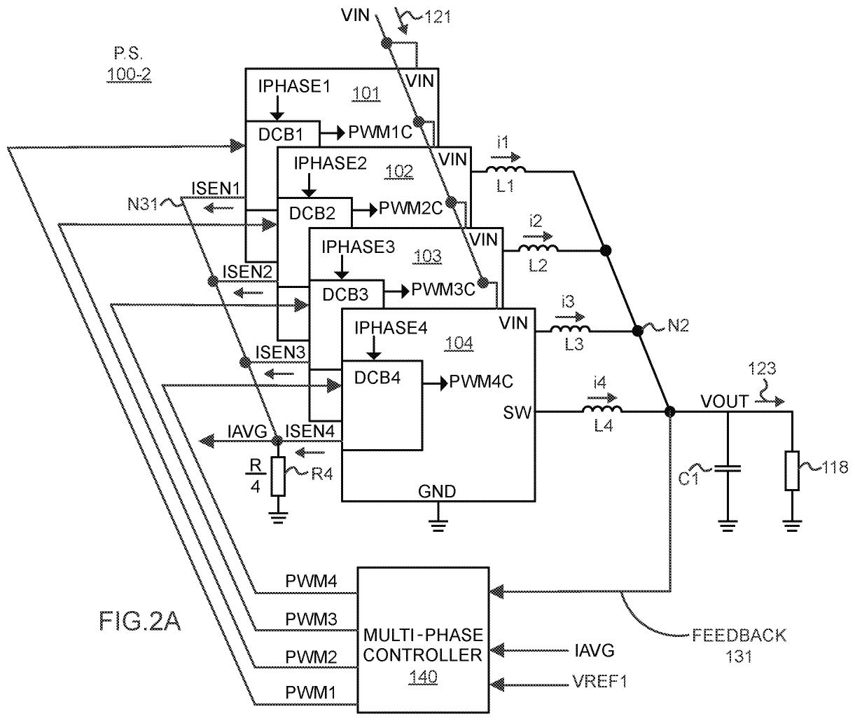

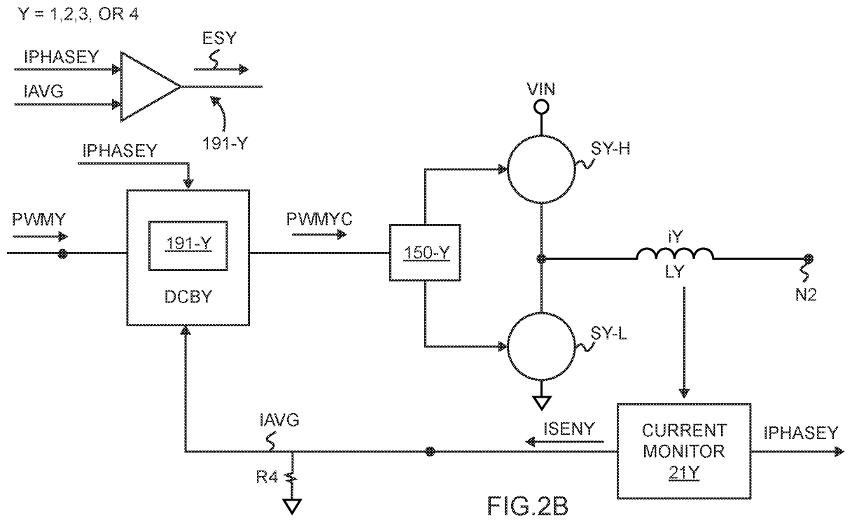

FIG. 2A is an example diagram illustrating implementation of the power converter including multiple power converter phases controlled by a multiphase controller as discussed herein.

As shown, power supply 100-2 in FIG. 2A includes controller 140 (such as a multiphase controller, current controller, controller hardware, etc.), resistor R4, power converter phase 101, power converter phase 102, power converter phase 103, power converter phase 104, output capacitor C1, and dynamic load 118.

Each of the power converters as discussed herein can be configured to include a respective current balancer function (a.k.a., current balancer, controller, hardware, circuitry, etc., such as being digital-circuit-based, analog-circuit-based, or a combination of analog-circuit-based and digital-circuit-based). For example, the power converter phase 101 includes current balance function DCB1, the power converter phase 102 includes current balance function DCB2, the power converter phase 103 includes current balance function DCB3, the power converter phase 104 includes the current balance function DCB4.

Accordingly, each current balance function as discussed herein can be considered a controller, signal generator, etc.

Each of the power converter phases in the power supply 100-1 produces a respective feedback signal indicating a magnitude of corresponding current supplied by that power converter phase to the load 118.

For example, the power converter phase 101 includes a corresponding current monitor operative to measure a magnitude of the current I1 supplied by the power converter phase 101 through the inductor L1 to the corresponding load 118. The current i1 contributes to maintaining a magnitude of the output voltage 123 at a desired setpoint reference voltage VREF1. The current balance function DCB1 produces the respective signal ISEN1 indicating a magnitude of the current i1. In one example, the signal ISEN1 is a current proportional to the magnitude of the current i1. The signal ISEN1 is outputted from the corresponding current balance function DCB1 to the node N31 (circuit path), where the corresponding current from the signal ISEN1 flows through the resistor R4 to the ground reference voltage.

The power converter phase 102 includes a corresponding current monitor operative to measure a magnitude of the current i2 supplied by the power converter phase 102 through the inductor L2 to the corresponding load 118. The current i2 contributes to maintaining a magnitude of the output voltage 123 at a desired setpoint reference voltage VREF1. The current balance function DCB2 produces the respective signal ISEN2 indicating a magnitude of the current i2. In one example, the signal ISEN2 is a current proportional to the magnitude of the current i2. The signal ISEN2 is outputted from the corresponding current balance function DCB2 to the node N31, where the corresponding current from the signal ISEN2 flows through the resistor R4 to the ground reference voltage.

The power converter phase 103 includes a corresponding current monitor operative to measure a magnitude of the current i3 supplied by the power converter phase 103 through the inductor L3 to the corresponding load 118. The current i3 contributes to maintaining a magnitude of the output voltage 123 at a desired setpoint reference voltage VREF1. The current balance function DCB3 produces the respective signal ISEN3 indicating a magnitude of the current i3. In one example, the signal ISEN3 is a current proportional to the magnitude of the current i3. The signal ISEN3 is outputted from the corresponding current balance function DCB3 to the node N31, where the corresponding current from the signal ISEN3 flows through the resistor R4 to the ground reference voltage.

The power converter phase 104 includes a corresponding current monitor operative to measure a magnitude of the current i4 supplied by the power converter phase 104 through the inductor L4 to the corresponding load 118. The current i4 contributes to maintaining a magnitude of the output voltage 123 at a desired setpoint reference voltage VREF1. The current balance function DCB4 produces the respective signal ISEN4 indicating a magnitude of the current i4. In one example, the signal ISEN4 is a current proportional to the magnitude of the current i4. The signal ISEN4 is outputted from the corresponding current balance function DCB4 to the node N31, where the corresponding current from the signal ISEN4 flows through the resistor R4 to the ground reference voltage.

In such an instance, the voltage IAVG at node N31 indicates a magnitude of total current (such as magnitude of total current is being summation of currents i1, i2, i3, and i4) provided by the power converter phases 101, 102, 103, and 104, to the load 118. Accordingly, communication of the signal IAVG to the controller 140 indicates a total current provided by a combination of the power converter phases to the load 118.

As further shown in FIG. 2A, the controller 140 can be configured to receive feedback signal 131 indicating a magnitude of the output voltage 123. Note further that the controller 140 also receives the setpoint reference voltage VREF1, indicating desired magnitude in which to control the magnitude of the output voltage 123.

The controller 140 generates the pulse width modulation control signals PWM1 to control a magnitude of respective output current i1 supplied by the power converter phase 101 to the load 123.

The controller 140 generates the pulse width modulation control signals PWM2 to control a magnitude of respective output current i2 supplied by the power converter phase 102 to the load 123.

The controller 140 generates the pulse width modulation control signals PWM3 to control a magnitude of respective output current i3 supplied by the power converter phase 103 to the load 123.

The controller 140 generates the pulse width modulation control signals PWM4 to control a magnitude of respective output current i4 supplied by the power converter phase 104 to the load 123.

In furtherance of controlling the magnitude of the output voltage 123, the controller 140 produces the respective pulse width modulation control signals PWM1, PWM2, PWM3, and PWM4. Rather than simply use the received pulse width modulation control signal received from the controller 140, each of the power converter phases implements a respective current balance function that supports equalizing the magnitude of the output currents outputted to the load 118.

More specifically, the controller 140 produces the respective pulse width modulation control signal PWM1 and supplies it to the power converter 101. As discussed herein, the respective current balance function DCB1 of the power converter 101 adjusts the pulse width modulation control signal PWM1 to produce the pulse width modulation control signal PWM1C; the respective current balance function DCB2 of the power converter 102 adjusts the pulse width modulation control signal PWM2 to produce the pulse width modulation control signal PWM2C; the respective current balance function DCB3 of the power converter 103 adjusts the pulse width modulation control signal PWM3 to produce the pulse width modulation control signal PWM3C; the respective current balance function DCB4 of the power converter 104 adjusts the pulse width modulation control signal PWM4 to produce the pulse width modulation control signal PWM4C; and so on.

Thus, the function of providing current balance amongst the multiple power converter phases is distributed to the power converter phases themselves as opposed to the controller 140 having the burden of producing and transmitting individual control signals to balance current from each of the power converter phases.

FIG. 2B is an example diagram illustrating a power converter and corresponding circuitry as discussed herein.

This example illustrates the circuitry associated with each of the power converter phases 10Y as shown in FIG. 2A. As discussed below, the value of Y may be 1, 2, 3, or 4. If desired, this can be extended to include any number of PWM signals.

For example, each respective power converter phase 10Y includes a current balance function DCBY, driver circuitry 150-Y, highside switch circuitry SY-H, low side switch circuitry SY-L, inductor LY, and current monitor 2Y.

As previously discussed, the current balance function DCBY receives the pulse width modulation control signal PWMY generated by the controller 140. The current balance function DCBY also receives a signal IPHASEY indicating a magnitude of respective output current iY supplied by that power converter phase 10Y to the load 118.

Additionally, as previously discussed, the current balance function DCBY receives the signal IAVG. The current balance function DCBY further includes a comparator function 191-Y (such as an error signal generator). As its name suggests, the comparator function 191-Y (difference function) is configured to compare the signal IAVG (setpoint value or target value) and the signal (IPHASEY) to produce the respective error signal ESY. The error signal ESY indicates a respective difference between the actual output current iY supplied to the load 118 with respect to the desired setpoint output current value IAVG. For example the error signal ESY can be set to signal IAVG minus signal IPHASEY.

If the magnitude of the error signal ESY is equal to 0, then the pulse width modulation control signal PWMYc outputted from the current balance function DCBY is basically identical to the received pulse width modulation signal PWMY with a small delay on each respective leading edge and trailing edge.

If the magnitude of the error signal ESY is a negative value (polarity is a first state) indicating that the magnitude of the output current iY as indicated by the signal IPHASEY is greater than a magnitude of current as indicated by the signal IAVG, then the current balance function DCBY produces the respective pulse width modulation control signal PWMYC for a next control cycle with a shorter duty cycle (shorter pulse width) of activating respective highside switch circuitry SY-H with respect to the original duty cycle as indicated by the pulse width modulation control signal PWMY.

If the magnitude of the error signal ESY is a positive value (polarity is a second state) indicating that the magnitude of the output current iY as indicated by the signal IPHASEY is less than a magnitude of current as indicated by the signal IAVG, then the current balance function DCBY produces the respective pulse width modulation control signal PWMYC for a next control cycle with a higher duty cycle (longer pulse width) of activating respective highside switch circuitry SY-H with respect to the original duty cycle as indicated by the pulse width modulation control signal PWMX.

Thus, controlled activation of high side switch circuitry SY-H in the first power converter phase via the control signal PWMYc can be used to ensure that a magnitude of the output current iY is substantially equal to the magnitude of average current as indicated by the signal IAVG over time.

As discussed herein, the duty cycle or pulse width associated with the adjusted pulse width modulation control signal PWMYC can be increased or decreased by adjusting one or more of a leading edge and/or a trailing edge of the corresponding control signal PWMYC. Thus, the leading edge or trailing edge of the control signal PWMYC can be adjusted based on a difference between an average magnitude of the output currents (IAVG) and a determined magnitude of the first output current (IPHASEY) outputted from the respective power converter 10Y to the load 118.

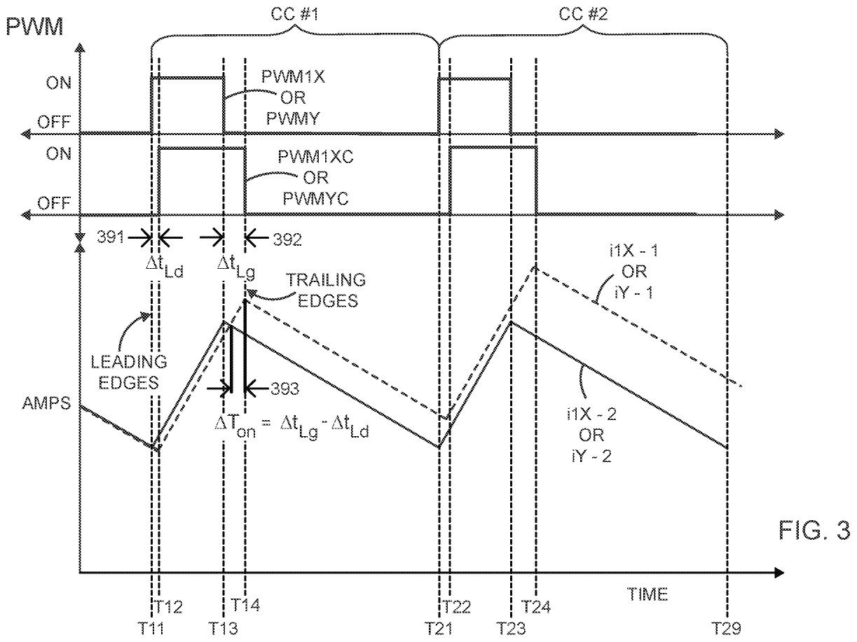

FIG. 3 is an example timing diagram illustrating adjustment of a trailing edge of a pulse width modulation control signal as discussed herein.

In this example of implementing trailing edge timing adjustments, based on FIG. 1A, the current balance function DCB1X (where X equals 1 or 2) receives the control signal PWM1 as previously discussed and converts it into the respective control signal PWM1XC. In the case where the magnitude of the output current i1X as indicated by the signal IPHASE1X is less than the target average current value IAVG1, the corresponding current balance function DCB1X delays the respective trailing edge of the control signal PWMXC, resulting in an increased time in which the highside switch circuitry SIX-H is activated in a respective control cycle. In other words, the delay of the trailing edge (from time T12 to time T13 or other suitable time such as is indicated by the trailing edge delay 392) associated with the control signal PWMXC resulting in a longer ON-time of the respective highside switch circuitry SIX-H in a respective control cycle increases a magnitude of the respective output current i1X supplied to the load 118 as shown in FIG. 3 by output current i1X-1. The signal i1X-2 in FIG. 3 indicates a lower magnitude of the output current i1X using the original signal PWM1X without lengthening an ON-time duration of the highside switch circuitry SIX-H via the delay of the trailing edge.

Thus the pulse width of the control signal PWM1X is between time T11 and time T13. The adjusted pulse width (longer pulse width) associated with the signal PWM1XC is between time T12 and time T14.

The current balance functions in FIG. 2A operate in a similar manner. More specifically, in this example of implementing trailing edge timing adjustments, the current balance function DCBY (where Y equals 1 to 4) receives the control signal PWMY and converts it into the control signal PWMYC in a manner as previously discussed. In the case where the magnitude of the output current iY as indicated by the signal IPHASEY is less than the target average current value IAVG, the corresponding current balance function DCB1Y delays the respective trailing edge of the control signal PWMYC, resulting in an increased time in which the highside switch circuitry SIY-H is activated in a respective control cycle. The delay of the trailing edge (from time T12 to time T13 or other suitable time) associated with the control signal PWMYC results in a longer ON-time of the respective highside switch circuitry SY-H in a respective control cycle increases a magnitude of the respective output current iY supplied to the load 118 as shown in FIG. 3 by output current iY-1. The signal iY-2 in FIG. 3 indicates a lower magnitude of the output current iY without lengthening an ON-time duration of the highside switch circuitry SY-H.

It is noted that adjustment of the trailing edge of the respective control signal such as via the delay delta TON as discussed herein changes the pulse width ON duration associated with the originally received pulse width modulation signal PWM1X or PWMY to produce the corresponding pulse width modulation control signal PWM1XC or PWMYC without a change in a corresponding switching frequency. In other words, the switching frequency of the trailing edge adjusted pulse width modulation control signal produced and outputted by the current balance function is the same as the pulse width modulation control signal received by the current balance function from the controller 140. As further shown in FIG. 3, the period associated with cycle #1 is to the period associated with cycle #2.

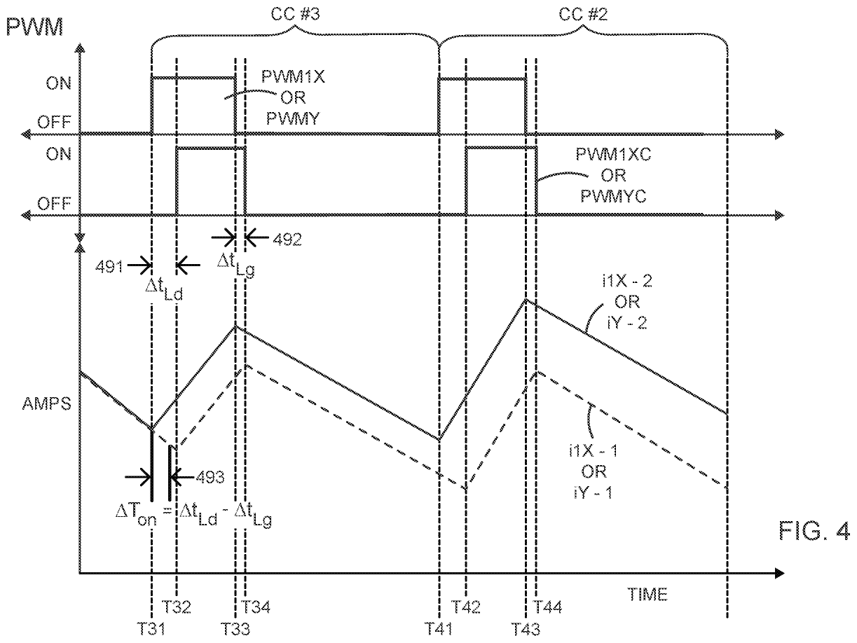

FIG. 4 is an example timing diagram illustrating adjustment of a leading edge of a pulse width modulation control signal as discussed herein.

In this example of implementing leading-edge timing adjustments, based in FIG. 1A, the current balance function DCB1X (where X equals 1 or 2) receives the control signal PWM1 and converts it into the control signal PWMXC. In the case where the magnitude of the output current i1X as indicated by the signal IPHASE1X is greater than the target average current value IAVG1, the corresponding current balance function DCB1X delays the respective leading edge of the control signal PWMXC, resulting in an decreased time in which the highside switch circuitry SIX-H is activated in a respective control cycle. The delay such as delay 491 of the leading edge (from around time T31 to time T32 or other suitable time) associated with the control signal PWMXC resulting in a shorter ON-time of the respective highside switch circuitry SIX-H in a respective control cycle decreases a magnitude of the respective output current i1X supplied to the load 118 as shown in FIG. 4 by output current i1X-1. The signal i1X-2 in FIG. 4 indicates a higher magnitude of the output current i1X without decreasing an ON-time duration of the highside switch circuitry SIX-H, thus, the current balancer function as discussed herein can be configured to delay the leading edge of the control signal PWM1XC by an amount of delay 491 as well as delay the trailing edge of the control signal PWM1XC by an amount of delay 492 to produce the control signal PWM1XC1.

The current balance functions in the power supply of FIG. 2A operate in a similar manner. More specifically, in this example of implementing leading edge timing adjustments, the current balance function DCBY (where Y equals 1 to 4) receives the control signal PWMY and converts it into the control signal PWMYC. In the case where the magnitude of the output current iY as indicated by the signal IPHASEY is greater than the target average current value IAVG, the corresponding current balance function DCB1Y delays the respective leading edge of the control signal PWMYC such as by amount delay 491, resulting in a decreased time in which the highside switch circuitry S1Y-H is activated in a respective control cycle. The delay of the leading edge (from time T31 to time T32 or other suitable time such as delay time 491) associated with the control signal PWMYC resulting in a shorter ON-time of the respective highside switch circuitry SY-H in a respective control cycle decreases a magnitude of the respective output current iY supplied to the load 118 as shown in FIG. 4 by output current iY-1. The signal iY-2 in FIG. 4 indicates a higher magnitude of the output current iY without shortening an ON-time duration of the highside switch circuitry SY-H.

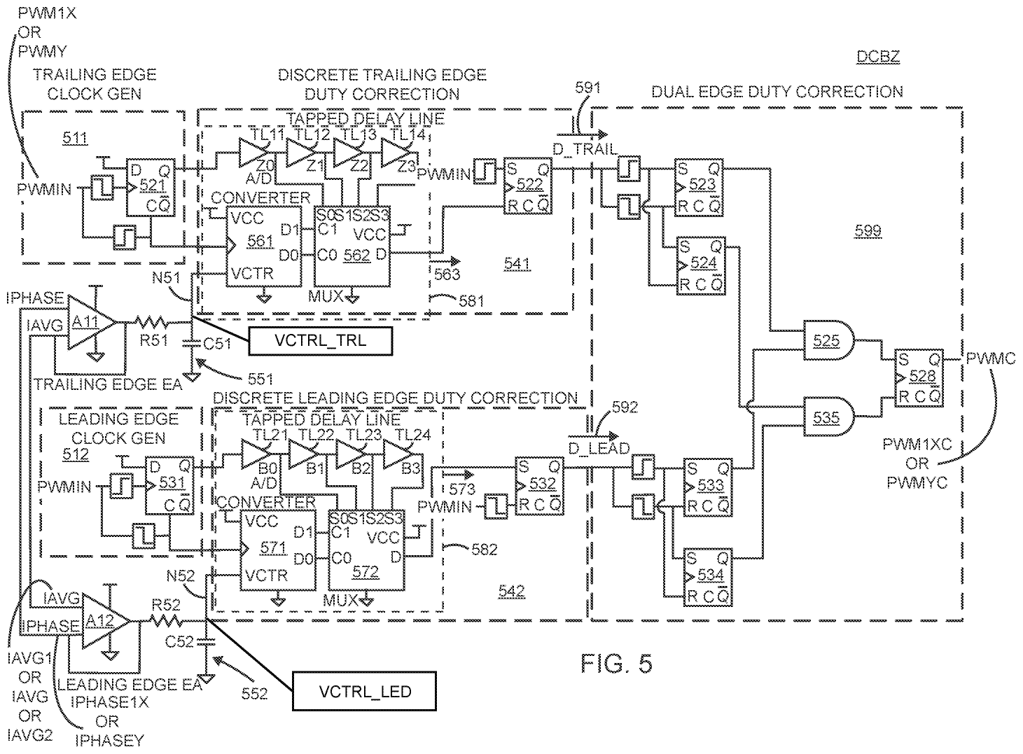

FIG. 5 is an example diagram illustrating a pulse width modulation signal generator operable to adjust leading and trailing edges of a respective received control signal as discussed herein.

In this example, the current balance function DCBz (such as any of the current balance functions DCB11, DCB12, DCB21, DCB22, DCB1, DCB2, DCB3, DCB4, etc., as previously discussed) includes a respective instance of the circuitry shown in FIG. 5 such as amplifier A11, amplifier A12, integrator circuit 551, integrator circuit 552, a trailing edge clock generator 511, leading-edge clock generator 512, circuitry 541 providing discrete trailing edge duty correction, circuitry 542 providing discrete leading edge duty correction, and circuitry 599 providing dual edge duty correction.

As further shown, the integrator circuit 551 includes a resistor R51 and capacitor C51. The integrator circuit 552 includes a resistor R52 and a capacitor C52.

The trailing edge clock generator 511 includes the D flip-flop element 521. The leading edge clock generator 512 includes the D flip-flop element 531.

In this example, the signal PWM IN represents the corresponding signal PWM1, PWM2, PWM3, PWM4, PWM1X, PWMY, etc., as previously discussed. The trailing edge clock generator 511 includes the D flip-flop 521 that forwards the received PWMIN clock signal to the tapped delay line including series connected tapped delay line element TL11, tapped delay line element TL12, tapped delay line element TL13, tapped delay line element TL14. As their names suggest, each of the tapped delay line elements delays the respective input pulse width modulation PWM IN signal by a same or different amount of time.

The integrator circuit 551 includes the amplifier A11, resistor R51 and capacitor C51. The amplifier A11 produces a respective signal VCTRL_TRL indicating or based on a difference between the IPHASE signal (such as any of IPHASE11, IPHASE12, IPHASE21, IPHASE22, IPHASE1, IPHASE2, IPHASE3, IPHASE4) and the IAVG signal (such as any of IAVG1, IAVG2, IAVG, etc.) depending on the instantiation of the current balance function. The node N51 connecting the resistor R51 and the capacitor C51 stores a respective error signal VCTRL_TRL supplied to the analog-to-digital converter 561. The analog-to-digital converter 561 converts the received signal VCTRL_TRL into signals DI and DO supplied to the multiplexer 562. The multiplexer 562 uses the received signals DI and DO as address lines to select which delayed version of the PWM signal to output as signal 563 to the D flip-flop 522. Subsequent circuitry such as D flip-flop 523, D flip-flop 524, logic 525, D flip-flop 528, use the signal 591 as a basis in which to control adjustment of the trailing edge of the signal PWMC (such as signal PWM1XC or PWMYC) as indicated in the prior timing diagrams.

Via the current balance function (i.e., circuit) shown in FIG. 5, as previously discussed, when the magnitude of the current supplied by the corresponding power converter phase as indicated by the signal IPHASE is less than the current as specified by the signal IAVG, the trailing edge of the respective signal PWMC is delayed by varying amounts as selected by the multiplexer 562.

For example, the analog-to-digital converter 561 produces selection signals in which C0=0 and C1=0 (inputs to the multiplexer 562) in response to a condition that the magnitude of current as indicated by the signal IPHASE is less than or equal to the signal IAVG (based on the magnitude of the error signal VCTRL_TRL). In such an instance, the multiplexer 562 selects the signal Z0 (1 unit or minimum time delay for the trailing edge delay time 392) to output as signal 563.

The analog-to-digital converter 561 produces selection signals in which C1=0 and C0=1 (inputs to the multiplexer 562) in response to a condition that the magnitude of current as indicated by the signal IPHASE is 2 amps or other suitable value less than the amperage as indicated by the signal IAVG (based on the magnitude of the error signal VCTRL_TRL). In such an instance, the multiplexer 562 selects the signal Z1 (2 unit time delay 392 of the trailing edge) to output as signal 563. Via the trailing edge delay as shown in FIG. 3, the delay of the trailing edge as indicated by the signal Z1 increases a magnitude of the ON-time associated with the highside switch circuitry as previously discussed such that the actual current provided by the power converter phase is nearer to the value as indicated by the signal IAVG.

The analog-to-digital converter 561 produces selection signals in which C1=1 and C0=0 (inputs to the multiplexer 562) in response to a condition that the magnitude of current as indicated by the signal IPHASE is 4 amps or other suitable value less than the amperage as indicated by the signal IAVG (based on the magnitude of the error signal VCTRL_TRL). In such an instance, the multiplexer 562 selects the signal Z2 (4 unit time delay 392 of the trailing edge) to output as signal 563. Via the trailing edge delay as shown in FIG. 3, the delay of the trailing edge as indicated by the signal Z2 increases a magnitude of the ON-time associated with the highside switch circuitry as previously discussed such that the actual current provided by the power converter phase is nearer to the value as indicated by the signal IAVG.

The analog-to-digital converter 561 produces selection signals in which C1=1 and C0=1 (inputs to the multiplexer 562) in response to a condition that the magnitude of current as indicated by the signal IPHASE is 6 amps or other suitable value less than the amperage as indicated by the signal IAVG (based on the magnitude of the error signal VCTRL_TRL). In such an instance, the multiplexer 562 selects the signal Z3 (6 unit time delay time 392 of the trailing edge) to output as signal 563. Via the trailing edge delay as shown in FIG. 3, the delay of the trailing edge as indicated by the signal Z3 increases a magnitude of the ON-time associated with the highside switch circuitry as previously discussed such that the actual current provided by the power converter phase is nearer to the value as indicated by the signal IAVG.

In this example, as previously discussed, the signal PWM IN represents the corresponding signal PWM1, PWM2, PWM3, PWM4, PWM1X, PWMY, etc., as previously discussed. The trailing edge clock generator 512 includes the D flip-flop 531 that forwards the PWMIN clock signal to the tapped delay line including tapped delay line element TL21, tapped delay line element TL22, tapped delay line element TL23, tapped delay line element TL24. As their names suggest, each of the tapped delay line elements delays the respective input pulse width modulation PWM IN signal.

The integrator circuit 552 includes the amplifier A12, resistor R52 and capacitor C52. The amplifier A12 produces a respective signal VCTRL_LED based on or indicating a difference between the IPHASE signal (such as any of IPHASE11, IPHASE12, IPHASE21, IPHASE22, IPHASE1, IPHASE2, IPHASE3, IPHASE4) and the IAVG signal (such as any of IAVG1, IAVG2, IAVG, etc.). The node N52 connecting the resistor R52 and the capacitor C52 stores a respective error signal VCTRL_LED supplied to the analog-to-digital converter 571. The analog-to-digital converter 571 converts the received signal VCTRL_LED into signal DI and DO supplied to the multiplexer 572. The multiplexer 572 uses the received signals DI and DO to select which delayed version of the PWM signal to output as signal 573 to the D flip-flop 532. Subsequent circuitry such as D flip-flop 533, D flip-flop 534, logic 535, D flip-flop 528, use the signal 592 as a basis in which to control adjustment of the leading edge of the signal PWMC (such as signal PWM1XC or PWMYC) on an as needed basis.

Via the current balance function (i.e., circuit) shown in FIG. 5, as previously discussed, when the magnitude of the current supplied by the corresponding power converter phase as indicated by the signal IPHASE is greater than the current as specified by the signal IAVG, the leading edge of the respective signal PWMC is delayed by varying amounts as selected by the multiplexer 572.

For example, the analog-to-digital converter 571 produces selection signals in which C0=0 and C1=0 (inputs to the multiplexer 572) in response to a condition that the magnitude of current as indicated by the signal IPHASE is greater than or equal to the signal IAVG (based on the magnitude of the error signal VCTRL_LED). In such an instance, the multiplexer 572 selects the signal B0 (1 unit or minimum time delay of the leading edge time delay 491 of FIG. 4) to output as signal 573.

The analog-to-digital converter 571 produces selection signals in which C1=0 and C0=1 (inputs to the multiplexer 572) in response to a condition that the magnitude of current as indicated by the signal IPHASE is 2 amps or other suitable value greater than the amperage as indicated by the signal IAVG (based on the magnitude of the error signal VCTRL_LED). In such an instance, the multiplexer 572 selects the signal B1 (2 unit time delay 491 of the leading edge in FIG. 4) to output as signal 573. Via the leading edge delay as shown in FIG. 4, the delay of the leading edge as indicated by the signal B1 decreases a magnitude of the ON-time associated with the highside switch circuitry as previously discussed such that the actual current provided by the power converter phase is nearer to the value as indicated by the signal IAVG.

The analog-to-digital converter 571 produces selection signals in which C1=1 and C0=0 (inputs to the multiplexer 572) in response to a condition that the magnitude of current as indicated by the signal IPHASE is 4 amps or other suitable value greater than the amperage as indicated by the signal IAVG (based on the magnitude of the error signal VCTRL_LED). In such an instance, the multiplexer 572 selects the signal B2 (4 unit time delay 491 of the leading edge as in FIG. 4) to output as signal 573. Via the leading edge delay as shown in FIG. 4, the delay of the leading edge as indicated by the signal B2 decreases a magnitude of the ON-time associated with the highside switch circuitry as previously discussed such that the actual current provided by the power converter phase is nearer to the value as indicated by the signal IAVG.

The analog-to-digital converter 571 produces selection signals in which C1=1 and C0=1 (inputs to the multiplexer 572) in response to a condition that the magnitude of current as indicated by the signal IPHASE is 6 amps or other suitable value greater than the amperage as indicated by the signal IAVG (based on the magnitude of the error signal VCTRL_LED). In such an instance, the multiplexer 572 selects the signal B2 (6 unit time delay 491 of the leading edge in FIG. 4) to output as signal 573. Via the leading edge delay as shown in FIG. 4, the delay of the leading edge as indicated by the signal B3 decreases a magnitude of the ON-time associated with the highside switch circuitry as previously discussed such that the actual current provided by the power converter phase is nearer to the value as indicated by the signal IAVG.

Thus the current balance circuit DCB as shown in FIG. 5 provides leading-edge or trailing edge adjustments to reduce the control signal PWMc depending upon whether the output current from that phase is greater than, equal to, or less than the desired average current value as indicated by the corresponding signal IAVG for that power converter phase.

Thus, derivation of the control signal PWMC from the received control signal PWM IN may include, depending upon whether the output current provided by the corresponding power converter phase is greater or less than the IAVG, selection of a first delay signal from a first tapped delay line to control a respective timing of a leading edge of the control signal PWMC; and selection of a second delay signal from a second tapped delay line to control a respective timing of a trailing edge of the second control signal PWMC.

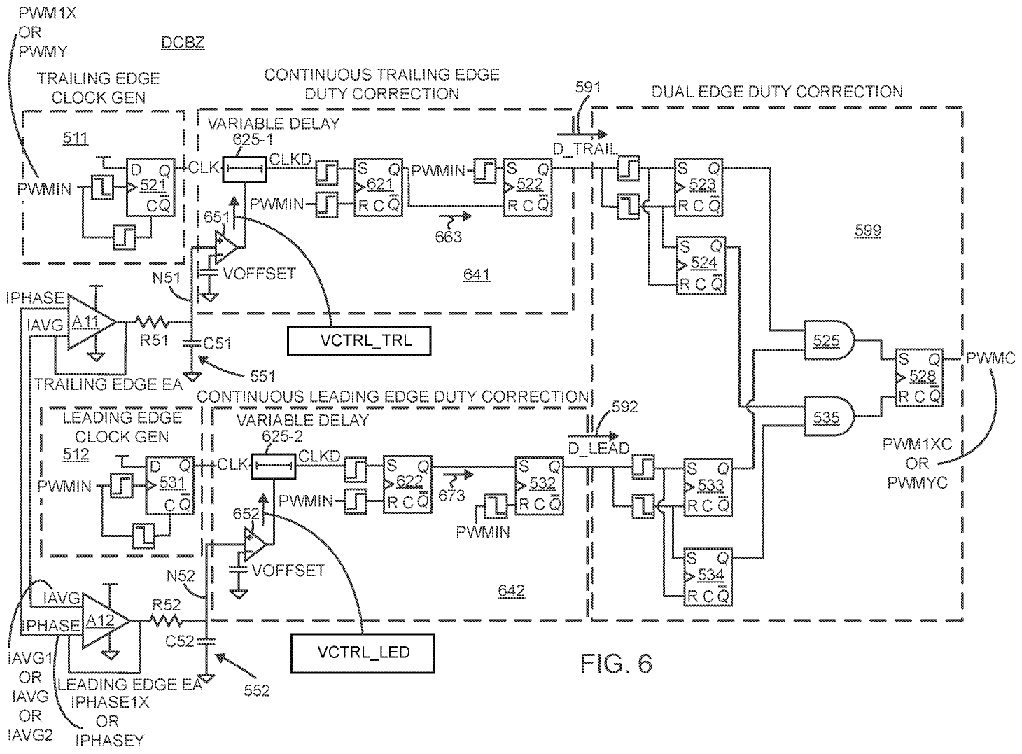

FIG. 6 is an example diagram illustrating a pulse width modulation signal generator operable to adjust leading and trailing edges of a respective received control signal as discussed herein.

In this example, the power converter phase DCBz includes the continuous trailing edge duty correction circuit 641 as a replacement to the discrete trailing edge duty correction circuit 541. Additionally, the power converter phase DCBz includes the continuous leading-edge duty correction circuit 642 as a replacement to the discrete leading edge duty correction circuit 542.

The continuous trailing edge duty correction circuit 641 includes a variable delay circuit 625-1, D flip-flop 621, D flip-flop 522, and amplifier circuitry 651. The continuous leading-edge duty correction circuit 642 includes a variable delay circuit 625-2, D flip-flop 622, D flip-flop 532, and amplifier circuitry 652.

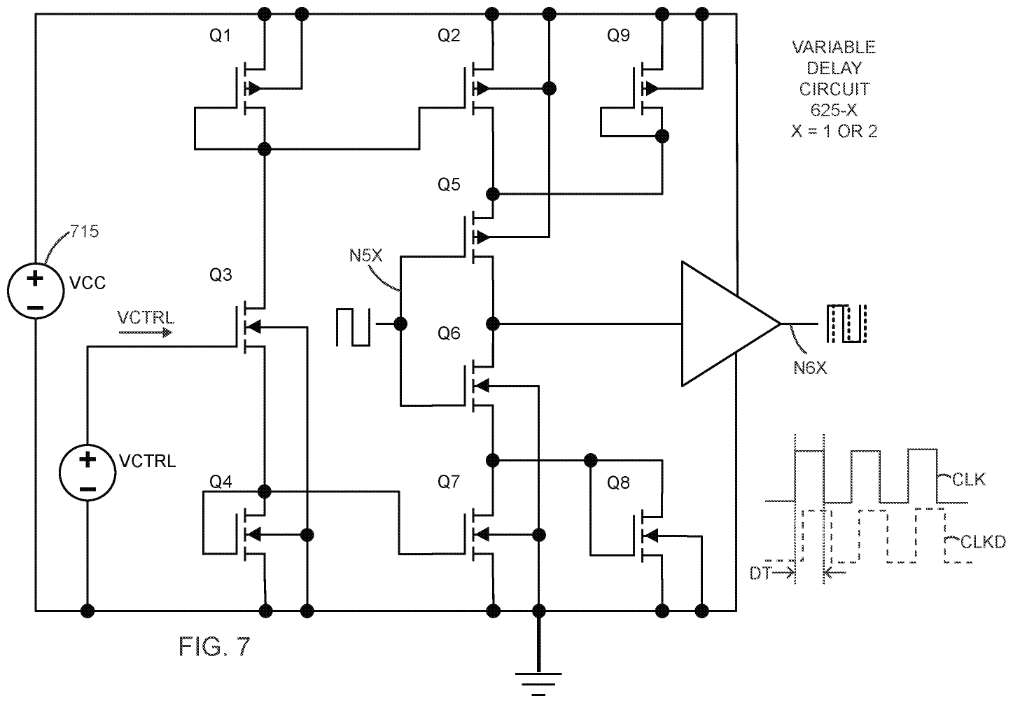

In similar manner as previously discussed, the integrator circuit 551 produces a respective voltage at node N51 indicating a magnitude of error between the signal IPHASE and IAVG. The error signal is conveyed to the amplifier circuitry 651, which converts the voltage at node N51 into a respective signal VCTRL_TRL supplied to the variable delay circuit 625-1. The variable delay circuit 625-1 receives the original signal PWMIN and, as its name suggests, varies an amount of delay (392) applied to the trailing edge of the received control signal PWMIN to produce the control signal PWMc depending upon a magnitude of the signal VCTL_TRL. Details of the variable delay circuit for 625-1 are shown in FIG. 7.

Via the current balance function (i.e., circuit) shown in FIG. 6, as previously discussed, when the magnitude of the current supplied by the corresponding power converter phase as indicated by the signal IPHASE is less than the current as specified by the signal IAVG, the trailing edge of the respective signal PWMC is delayed by varying amounts as selected by the variable delay circuit 625-X. For example, as the difference between the signal IPHASE and the signal IAVG increases (when IPHASE is less than IAVG), the magnitude of the delay (VCTRL) controlling adjustments to the trailing edge delay 392 of the final control signal PWMc also increases. Thus, as previously discussed, the magnitude of the pulse width on time associated with the control signal PWMc increases as the magnitude of the IPHASE becomes much less than the average current as indicated by IAVG.

FIG. 7 is an example diagram illustrating a variable delay circuit operative to delay a clock signal as discussed herein.

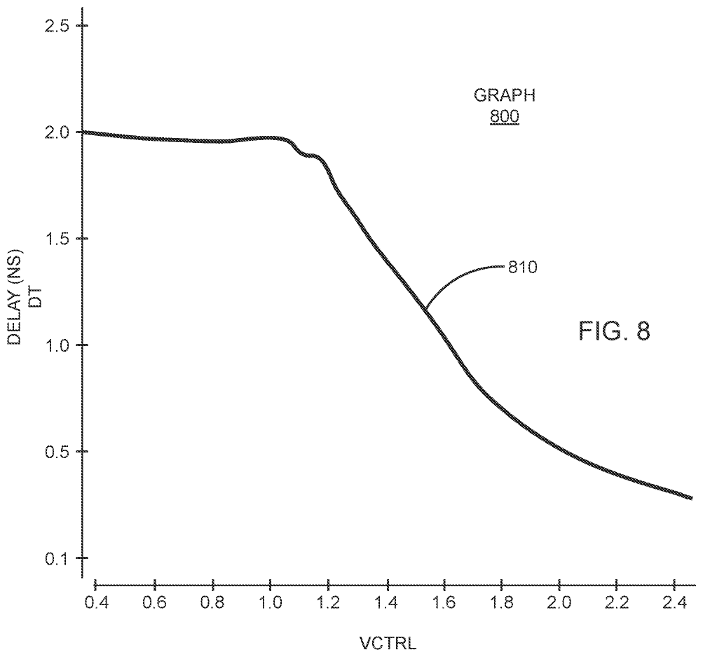

In this example, the variable delay circuit 625-X includes multiple field effect transistors Q1-Q9. Power source 715 applies the input voltage Vcc to power the corresponding variable delay circuit 625-X. The variable delay circuit 625-X receives the clock signal CLK at node N5X and outputs the delayed clock signal CLKd at node N6X. Graph 810 in the following FIG. 8 illustrates the amount of delay between the clock CLK and output a clock CLKd as a function of the inputted control signal VCTRL (for the leading edge VCTRL_TRL or the trailing edge VCTRL_LED).

In one example, the variable delay circuit 625-X may be a current starved inverter. In such an instance, the first power converter controller (such as current balance function DCB) associated with the power converter phase is configured to implement a first current starved inverter circuit (such as variable delay circuit 625-1) to convert the first control signal PWM IN (PWM1X) into the control signal PWM1XC, where the first current starved inverter circuit is operative to control timing of a trailing edge of the control signal PWMC on an as needed basis.

As previously discussed, the variable delay circuit 625-X may be a current starved inverter. In such an instance, the first power converter controller (such as current balance function DCB) associated with the power converter phase is configured to implement a second current starved inverter circuit (such as variable delay circuit 625-2) to convert the first control signal PWM IN (PWM1X) into the control signal PWM1XC, where the second current starved inverter circuit is operative to control timing of a leading edge of the control signal PWMC on an as needed basis.

FIG. 8 is an example diagram illustrating delay versus input voltage associated with the variable delay circuit as discussed herein.

In this example, the graph 800 includes function 810 indicating an amount of time delay (to delay the leading edge or to delay the trailing edge) provided by the variable delay circuit as previously discussed. Note that the function 810 may vary depending upon parameter such as temperature, etc., associated with the corresponding variable delay circuit.

Referring again to FIG. 6, in a similar manner as previously discussed, the integrator circuit 552 produces a respective voltage at node N52 indicating a magnitude of error between the signal IPHASE and IAVG. The signal at node N52 is conveyed to the amplifier circuitry 652, which converts the voltage at node N52 into a respective signal VCTRL_LED supplied to the variable delay circuit 625-2. The variable delay circuit 625-2 receives the original signal PWMIN and, as its name suggests, varies an amount of delay (491) applied to the leading edge of the received control signal PWMIN to produce the control signal PWMc depending upon a magnitude of the signal VCTL_LED. Details of the variable delay circuit for 625-2 are shown in FIG. 7.

Via the current balance function (i.e., circuit) shown in FIG. 6, as previously discussed, when the magnitude of the current supplied by the corresponding power converter phase as indicated by the signal IPHASE is greater than the current as specified by the signal IAVG, the leading edge of the respective signal PWMC is delayed by varying amounts as selected by the variable delay circuit 625-2. For example, as the difference between the signal IPHASE and the signal IAVG increases (when IPHASE is greater than IAVG), the magnitude of the delay (VCTRL) controlling adjustments to the leading edge of the final control signal PWMc also increases. Thus, as previously discussed, the magnitude of the pulse width on time associated with the control signal PWMc decreases as the magnitude of the IPHASE becomes much larger than the average current as indicated by IAVG.

Accordingly, examples herein include controlling a magnitude of a first delay amount 491 provided by a first current starved inverter circuit (625-2) to control the timing of the leading edge of the control signal PWMC based on a first error signal (signal VCTRL_LED) capturing a difference between a target value (IAVG) of controlling the magnitude of the corresponding output current of the power converter phase with respect to a measured magnitude of output current (IPHASE1) provided by that power converter phase.

In the opposite case, examples herein include controlling a magnitude of a second delay amount 391 provided by a second current starved inverter circuit (625-1) to control the timing of the trailing edge of the control signal PWMC based on a second error signal (signal VCTRL_TRL) capturing a difference between a target value (IAVG) of controlling the magnitude of the corresponding output current of the power converter phase with respect to a measured magnitude of output current (IPHASE1) provided by that power converter phase.

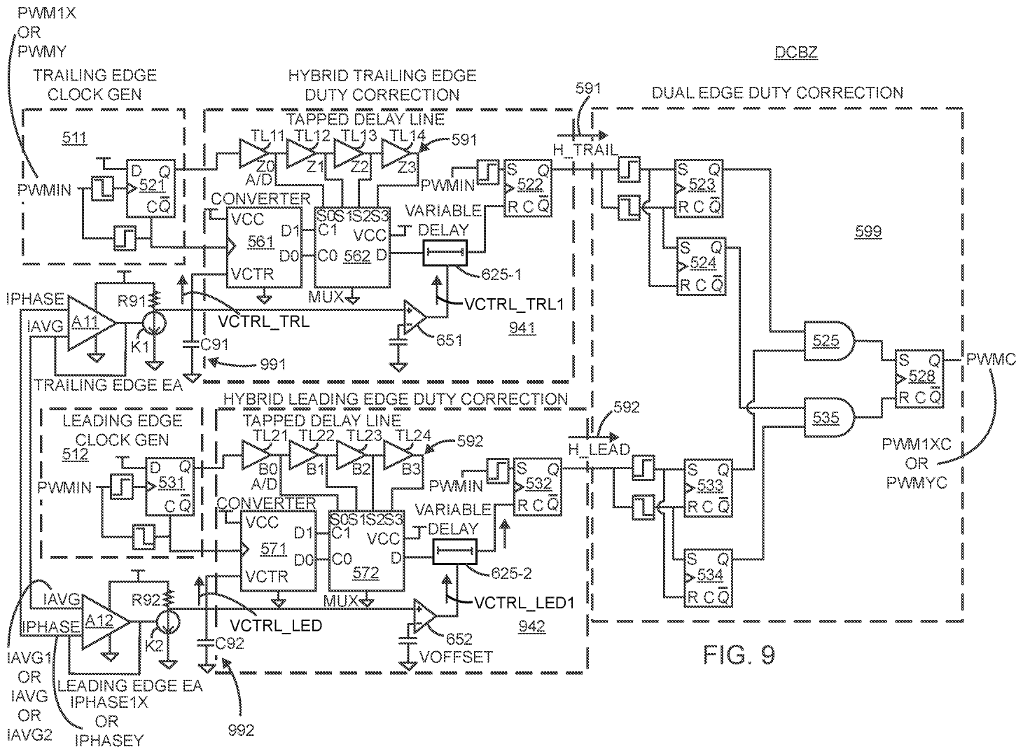

FIG. 9 is an example diagram illustrating a hybrid pulse width modulation signal generator as discussed herein.

In this example, the power converter phase DCBz includes the hybrid trailing edge duty correction circuit 941 as a replacement to the discrete trailing edge duty correction circuit 541 in FIG. 6. Additionally, the power converter phase DCBz includes the hybrid leading-edge duty correction circuit 942 as a replacement to the discrete leading edge duty correction circuit 542.

In this example, the circuit 991 such as a combination of the amplifier A11, resistor R91, capacitor C91, current source K1, etc., produces a respective control signal VCTRL_TRL based upon the difference between signal IPHASE and IAVG. The hybrid trailing edge duty correction circuit 941 includes multiple stages such as a series connection of circuit 581 and the variable delay circuit 625-1.

In a similar manner as previously discussed, the combination of analog-to-digital converter 561 and the multiplexer 562 associated with the circuit 581 provides a first amount of trailing edge delay.

The hybrid trailing edge duty correction circuit 941 further includes the circuit 651 to produce the control signal VCTRL_TRL1 from VCTRL_TRL. The control signal VCTRL_TRL1 controls the variable delay circuit 625-1 in a manner as previously discussed. The variable delay circuit 625-1 further provides additional delay associated with the trailing edge of the control signal PWMC when the magnitude of IPHASE is less than IAVG. Accordingly, the combination of the discrete delay function in the variable delay circuit delay the respective trailing edge by any suitable amount.

In this example, the circuit 992 such as a combination of the amplifier A12, resistor R92, capacitor C92, current source K2, etc., produces a respective control signal VCTRL_LED based upon the difference between signal IPHASE and IAVG. The hybrid trailing edge duty correction circuit 942 includes multiple stages such as a series connection of circuit 582 and the variable delay circuit 625-2. In a similar manner as previously discussed, the combination of analog-to-digital converter 562 and the multiplexer 562 associated with the circuit 582 provides a first amount of trailing edge delay. The hybrid trailing edge duty correction circuit 942 further includes the circuit 652 operative to produce the control signal VCTRL_LED1 from VCTRL_LED. The control signal VCTRL_LED1 controls the variable delay circuit 625-2 in a manner as previously discussed. The variable delay circuit 625-2 further provides additional delay associated with the trailing edge of the control signal PWMC when the magnitude of IPHASE is less than IAVG. Accordingly, the combination of the discrete delay function in the variable delay circuit delay the respective trailing edge by any suitable amount.

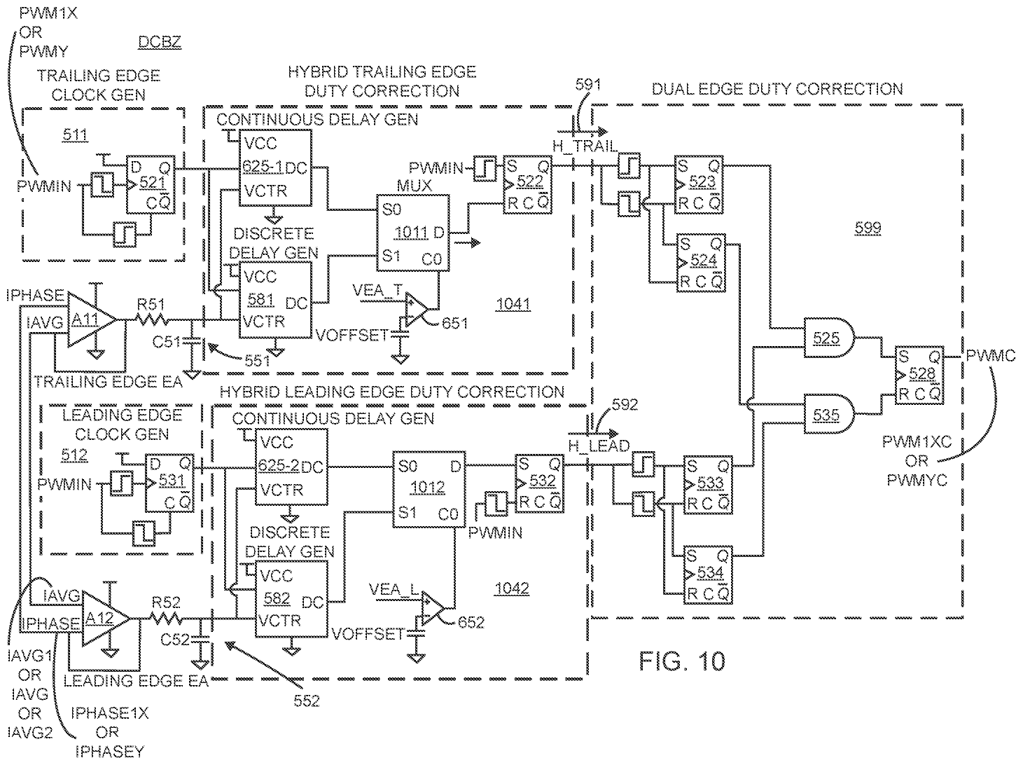

FIG. 10 is an example diagram illustrating a hybrid pulse width modulation signal generator as discussed herein.

In this example, the power converter phase DCBz includes the hybrid trailing edge duty correction circuit 1041 as a replacement to the discrete trailing edge duty correction circuit 541. Additionally, the power converter phase DCBz includes the hybrid leading-edge duty correction circuit 1042 as a replacement to the discrete leading edge duty correction circuit 542.

As shown in FIG. 10, the hybrid trailing edge duty correction circuit 1041 includes variable delay circuit 625-1 as well as the discrete delay circuit 581. The hybrid trailing edge duty correction circuit further includes circuit 651 to monitor a magnitude of the error associated with the difference between signal IPHASE and IAVG.

If the magnitude of the error is above a threshold, the circuit 651 causes the multiplexer to select channel S0 using the output of the variable delay circuit 625-1 to convey to D flip-flop 522, in which case the trailing edge associated with the signal PWMc is generated based on the output of the variable delay circuit 625-1.

Conversely, if the magnitude of the error is above a threshold, the circuit 651 causes the multiplexer to select channel S1 using the output of the circuit 581 conveyed to D flip-flop 522, in which case the trailing edge associated with the signal PWMc is generated based on the output of the circuit 581.

As further shown in FIG. 10, the hybrid leading edge duty correction circuit 1042 includes variable delay circuit 625-2 as well as the discrete delay circuit 582. The hybrid leading edge duty correction circuit further includes circuit 652 to monitor a magnitude of the error associated with the difference between signal IPHASE and IAVG.

If the magnitude of the error is above a threshold, the circuit 652 causes the multiplexer to select channel S0 using the output of the variable delay circuit 625-2 to convey to D flip-flop 532, in which case the leading edge associated with the signal PWMc is generated based on the output of the variable delay circuit 625-2.

Conversely, if the magnitude of the error is above a threshold, the circuit 652 causes the multiplexer to select channel S1 using the output of the circuit 582 to D flip-flop 532, in which case the leading edge associated with the signal PWMc is generated based on the output of the circuit 582.

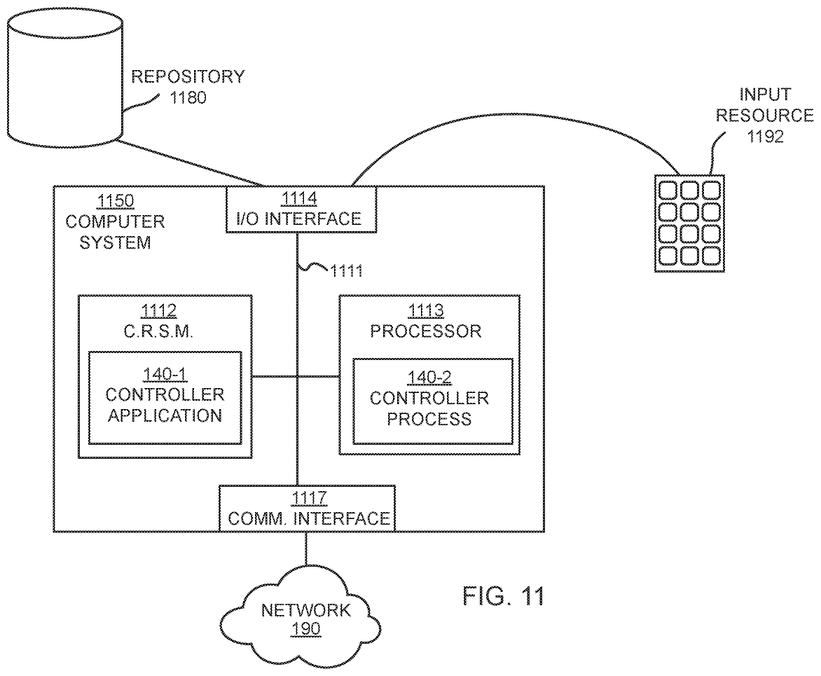

FIG. 11 is an example block diagram of a computer device for implementing any of the operations as discussed herein according to examples herein.

As shown, computer system 1150 (such as implemented by any of one or more resources such as controller 140, current balance functions DCB, etc.) of the present example includes an interconnect 1111 that couples computer readable storage media 1112 such as a non-transitory type of media (or hardware storage media) in which digital information can be stored and retrieved, a processor 1113 (e.g., computer processor hardware such as one or more processor devices), I/O interface 1114 (e.g., to output control signals to the power converter phases, monitor current, etc.), and a communications interface 1117.

I/O interface 1114 provides connectivity to any suitable circuitry such as power converter phases.

Computer readable storage medium 1112 can be any hardware storage resource or device such as memory, optical storage, hard drive, floppy disk, etc. In one example, the computer readable storage medium 1112 stores instructions and/or data used by the controller application 140-1 (such as implemented by any of controller 140, DCBs, etc., to support leading-edge and/or trailing edge signal adjustments) to perform any of the operations as described herein.

Further in this example, communications interface 1117 enables the computer system 1100 and processor 1113 to communicate over a resource such as network 190 to retrieve information from remote sources and communicate with other computers.

As shown, computer readable storage media 1112 is encoded with controller application 140-1 (e.g., software, firmware, etc.) executed by processor 1113. Controller application 140-1 can be configured to include instructions to implement any of the operations as discussed herein.

During operation of one example, processor 1113 accesses computer readable storage media 1112 via the use of interconnect 1111 in order to launch, run, execute, interpret or otherwise perform the instructions in controller application 140-1 stored on computer readable storage medium 1112.

Execution of the controller application 140-1 produces processing functionality such as controller process 140-1 in processor 1113. In other words, the controller process 140-B associated with processor 1113 represents one or more aspects of executing controller application 140-A within or upon the processor 1113 in the computer system 1100.

In accordance with different examples, note that computer system 1100 can be a micro-controller device, logic, hardware processor, hybrid analog/digital circuitry, etc., configured to control a power supply and perform any of the operations as described herein.

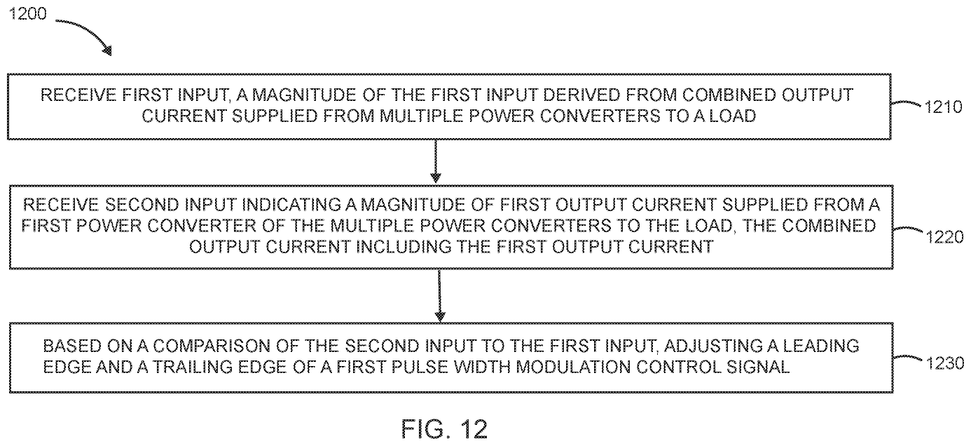

Functionality supported by the different resources will now be discussed via flowchart in FIG. 12. Note that the steps in the flowcharts below can be executed in any suitable order.

FIG. 12 is an example diagram illustrating a method of controlling a power converter and corresponding edge control according to examples herein.

In processing operation 1210, the current balance function DCB11 receives first input such as voltage IAVG1. A magnitude of the first input (voltage IAVG1 indicating the average current supplied by combination of the current i11 and current i12) is derived from combined output current (summation of i11+i12) supplied from multiple power converters (111 and 112) to the load 118.

In processing operation 1220, the current balance function DCB11 receives second input such as signal IPHASE11 indicating a magnitude of first output current i11 supplied from the first power converter 111 to the load 118. As previously discussed, the combined output current 122 supplied to the load 118 includes the output current i11.

In processing operation 1230, based on a comparison of the second input (signal IPHASE11) to the first input (IAVG1), the current balance function DCB11 adjusts a leading edge and/or a trailing edge of a first pulse width modulation control signal PWM1 to produce the respective adjusted pulse width modulation control signal PWM1c to control operation of switches (highside switch circuitry S1x-H and low side switch circuitry S1x-L, where X equals 1) in the power converter phase 111.

As previously discussed, the current balance function DCB 12 and other current balance functions operate in a similar manner as discussed above for current balance function DCB11.

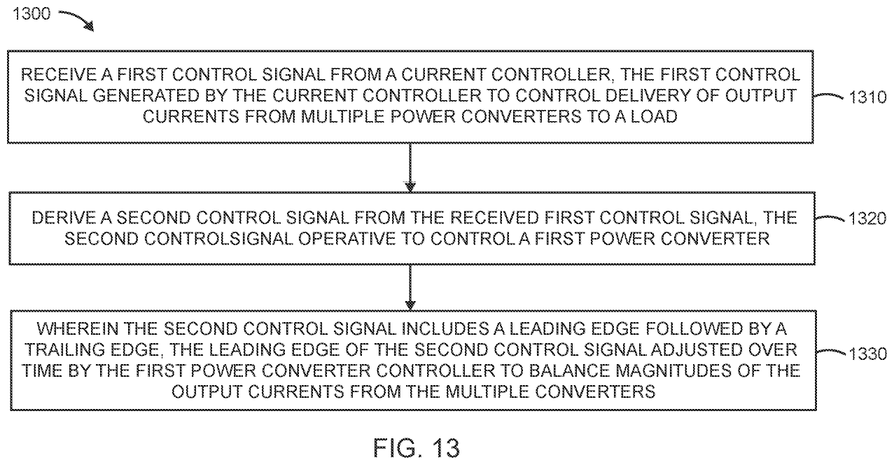

FIG. 13 is an example diagram illustrating a method of controlling a power converter and implementing corresponding edge control according to examples herein.

In processing operation 1310, the current balance function DCB11 receives a first control signal PWM1 from a current controller 140. The first control signal PWM1 is generated by the current controller 140 to control delivery of output currents (such as current i11, i12, etc.) from multiple power converters 111, 112, etc., to the load 118.

In processing operation 1320, the current balance function DCB11 derives a second control signal PWM1c from the received first control signal PWM1, wherein the second control signal PWM1c is operative to control operation of the first power converter 111.

In processing operation 1330, the second control signal PWM1c includes a leading edge followed by a trailing edge. In one example as discussed herein, the processing operation 1330 includes the current balance function DCB1 adjusting the leading edge and/or trailing edge associated with the second control signal PWM1c over time to balance magnitudes of the output currents (i11, 112, etc.) from the multiple converters to the load 118.

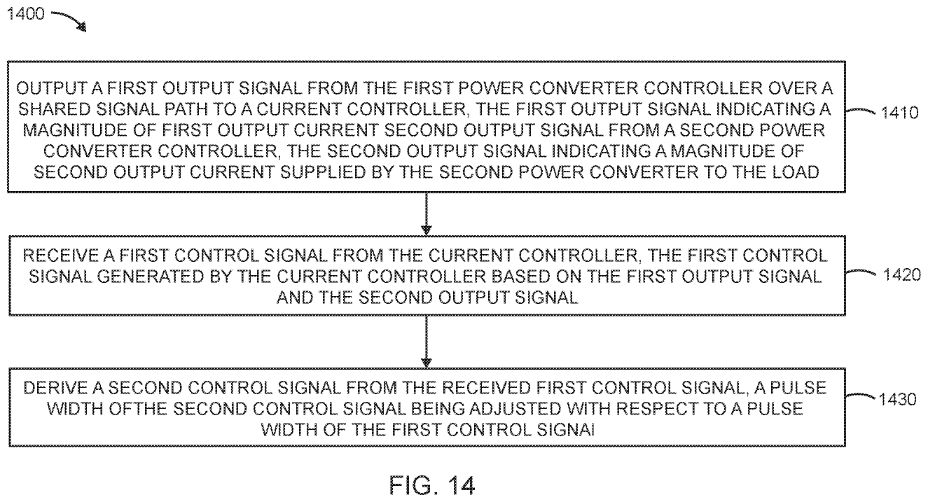

FIG. 14 is an example diagram illustrating a method of controlling a power converter and implementing corresponding edge control according to examples herein.

In processing operation 1410, the current balance function DCB11 (such as a first power converter controller associated with the power converter 111) output a first output signal ISEN11 over a shared signal path (node N11) to a current controller 140. The output signal indicates a magnitude of first output current i11 supplied by the first power converter phase 111 to the load 118. The shared signal path such as node N11 receives a second output signal ISEN12 from a second current balance function DCB 12 (such as a second power converter controller associated with the power converter 112). The second output signal ISEN12 indicates a magnitude of second output current i12 supplied by the second power converter 112 to the load 118.

In processing operation 1420, the current balance function DCB11 receives a first control signal PWM1 from the current controller 140. The first control signal PWM1 is generated by the current controller 140 based on a combination of the first output signal ISEN11 and the second output signal ISEN12. For example, the current ISEN11 and current ISEN12 produce the respective voltage signal IAVG1 indicating an average current supplied by combination of i11 and i12.

In processing operation 1430, the current balance function DCB11 associated with the power converter 111 derives a second control signal PWM1c from the received first control signal PWM1. Via implementation of a leading edge delay, a trailing edge delay, or combination of both, the current balance function DCB 11 adjusts a pulse width duration of the second control signal PWM1c with respect to a pulse width of the first control signal PWM1.

Note again that techniques herein are well suited for use in circuit applications such as those implementing power conversion. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An apparatus comprising:
a power converter controller operative to:
receive first input, a magnitude of the first input derived from combined output current supplied from multiple power converters to a load;
receive second input indicating a magnitude of first output current supplied from a first power converter of the multiple power converters to the load, the combined output current including the first output current; and
based on a comparison of the second input to the first input, adjusting a leading edge and a trailing edge of a first pulse width modulation control signal.

2. The apparatus as in claim 1, wherein the first pulse width modulation control signal is operative to control a magnitude of the first output current supplied from the first power converter.

3. The apparatus as in claim 1, wherein the adjusted leading edge and the trailing edge of the first pulse width modulation control signal is operative to set the magnitude of the first output current supplied from the first power converter to be substantially equal to the magnitude of the first input.

4. The apparatus as in claim 3, wherein a magnitude of the first input indicates an average magnitude of current supplied from the multiple power converters to the load.

5. The apparatus as in claim 1, wherein the power converter controller is further operative to:
receive the first pulse width modulation control signal from a pulse width modulation signal generator controlling operation of the multiple power converters;
derive a second pulse width modulation control signal from the received first pulse width modulation control signal the end the adjusted leading edge and the trailing edge leading-edge is a trailing edge; and
output the second pulse width modulation control signal to the first power converter.

6. The apparatus as in claim 5, wherein the first pulse width modulation control signal and the second pulse width modulation control signal are generated at a same frequency.

7. An apparatus comprising:
a first power converter controller operative to:
receive a first control signal from a current controller, the first control signal generated by the current controller to control delivery of output currents from multiple power converters to a load;
derive a second control signal from the received first control signal, the second control signal operative to control a first power converter; and
wherein the second control signal includes a leading edge followed by a trailing edge, the leading edge of the second control signal adjusted over time by the first power converter controller to balance magnitudes of the output currents from the multiple converters.

8. The apparatus as in claim 7, wherein the leading edge of the second control signal is adjusted based on a difference between an average magnitude of the output currents and a determined magnitude of the first output current outputted from the first power converter to the load.

9. An apparatus comprising:
a first power converter controller operative to:
output a first output signal from the first power converter controller over a shared signal path to a current controller, the first output signal indicating a magnitude of first output current supplied by a first power converter phase to a load, the shared signal path operative to receive a second output signal from a second power converter controller, the second output signal indicating a magnitude of second output current supplied by the second power converter to the load;
receive a first control signal from the current controller, the first control signal generated by the current controller based on the first output signal and the second output signal; and
derive a second control signal from the received first control signal, a pulse width of the second control signal being adjusted with respect to a pulse width of the first control signal.

10. The apparatus as in claim 9, wherein the first power converter controller is further operative to derive the second control signal based on a first delay value and a second delay value;
wherein a leading edge of the first control signal is delayed by the first delay value to produce a leading edge of the second control signal; and
wherein a trailing edge of the first control signal is delayed by the second delay value to produce a trailing edge of the second control signal.

11. The apparatus as in claim 10, wherein the first power converter controller is further operative to:
receive an input signal from the shared signal path, the received input signal indicating an average magnitude value based on the first output current supplied by the first power converter phase to the load and the second output current supplied by the second power converter phase to the load;
receive a first current monitor signal indicating the magnitude of the first output current; and
produce the first delay value and the second delay value based on a comparison of: i) the received input signal indicating the average magnitude value, and ii) the first current monitor signal indicating the magnitude of the first output current.

12. The apparatus as in claim 11, wherein the first power converter controller is further operative to:
adjust a magnitude of the first delay value and a magnitude of the second delay value such that the magnitude of the second pulse width is greater than the magnitude of the first pulse width in response to detecting a condition in which the magnitude of the first output current is less than the average magnitude value.

13. The apparatus as in claim 11, wherein the first power converter controller is further operative to:
adjust a magnitude of the first delay value and a magnitude of the second delay value such that the magnitude of the second pulse width is less than the magnitude of the first pulse width in response to detecting a condition in which the magnitude of the first output current is less than the average magnitude value.

14. The apparatus as in claim 11, wherein the first control signal is a first pulse width modulation control signal;
wherein the first power converter controller is operative to control the magnitude of the first output current based on the first pulse width modulation control signal received from the current controller; and
wherein the second power converter controller is operative to control the magnitude of the second output current based on the first pulse width modulation control signal received from the current controller.

15. The apparatus as in claim 9, wherein the first control signal is a first pulse width modulation control signal;
wherein the first power converter controller is operative to control the magnitude of the first output current based on the first pulse width modulation control signal received from the current controller; and
wherein the second power converter controller is operative to control the magnitude of the second output current based on a second pulse width modulation control signal received from the current controller.

16. The apparatus as in claim 9, wherein the first power converter controller is further operative to:
generate a first error signal based on a difference between a target value associated with producing the magnitude of the first output current and a measured magnitude of the first output current supplied to the load; and
generate a second error signal based on a difference between the target value associated with producing the magnitude of the first output current and the measured magnitude of the first output current supplied to the load.

17. The apparatus as in claim 16, wherein the first power converter controller is further operative to:
depending on a magnitude and polarity of the first error signal, adjust timing of a leading edge of the second control signal; and
depending on a magnitude and polarity of the second error signal, adjust timing of a trailing edge of the second control signal.

18. The apparatus as in claim 17, wherein the first power converter controller is further operative to:
control activation of high side switch circuitry in the first power converter via the second control signal, the controlled activation of the high side switch circuitry using the second control signal operative to substantially equalize the magnitude of the first output current and the second output current over time.

19. The apparatus as in claim 9, wherein derivation of the control signal from the received first control signal includes:
selection of a first delay signal from a first tapped delay line to control a respective timing of a leading edge of the second control signal; and
selection of a second delay signal from a second tapped delay line to control a respective timing of a trailing edge of the second control signal.

20. The apparatus as in claim 9, wherein the first power converter controller is operative to:
implement a first current starved inverter circuit to convert the first control signal into the second control signal, the first current starved inverter circuit operative to control timing of a leading edge of the second control signal; and
implement a second current starved inverter circuit to convert the first control signal into the second control signal, the second current starved inverter circuit operative to control timing of a trailing edge of the second control signal.

21. The apparatus as in claim 20, wherein a magnitude of a first delay amount provided by the first current starved inverter circuit to control the timing of the leading edge of the second control signal is based on a first error signal representing a difference between a target value of controlling the magnitude of the first output current with respect to a measured magnitude of the first output current; and
wherein a magnitude of a second delay provided by the second current starved inverter circuit to control the timing of the trailing edge of the second control signal is based on a second error signal representing a difference between the measured magnitude of the first output current with respect to the target value of controlling the magnitude of the first output current.

22. The apparatus as in claim 9, wherein the first power converter controller is operative to:
implement a first continuous delay element circuit to convert the first control signal into the second control signal, the first continuous delay element circuit operative to control timing of a leading edge of the second control signal; and
implement a second continuous delay element circuit to convert the first control signal into the second control signal, the second current continuous delay element circuit operative to control timing of a trailing edge of the second control signal.
